(19) United States
(12) Patent Application Publication
(10) Pub. No.: US 2024/0145707 A1
(43) Pub. Date: May 2, 2024

(54) CATHODE FOR LITHIUM-SULFUR BATTERIES

(71) Applicants: BAR-ILAN UNIVERSITY, Ramat Gan (IL); NICHIA CORPORATION, Anan-shi (JP)

(72) Inventors: Doron AURBACH, Bnei-Brak (IL); Shunsuke SAWADA, Anan-shi (JP); Shalom LUSKI, Rehovot (IL)

(21) Appl. No.: 18/497,567

(22) Filed: Oct. 30, 2023

Related U.S. Application Data
(60) Provisional application No. 63/420,880, filed on Oct. 31, 2022.

(51) Int. Cl. H01M 4/58; H01M 4/1397; H01M 4/36; H01M 4/583; H01M 4/62; H01M 10/052

(52) U.S. Cl. CPC H01M 4/5815; H01M 4/1397; H01M 4/366; H01M 4/583; H01M 4/623; H01M 10/052; H01M 2004/028

(57) ABSTRACT

A cathode for Li—S battery includes a current collector and a cathode composite layer disposed on the current collector. The cathode composite layer includes (i) a porous carbon layer, (ii) a first binder that is at least partially in contact with the porous carbon layer and (iii) elemental sulfur. A second binder is at least partially disposed between the current collector and the cathode composite layer. A Li—S battery also is contemplated, as are methods of fabricating the cathode and the battery.

### BACKGROUND OF THE INVENTION

There is a growing interest in lithium-sulfur batteries owing to their ability to power electric vehicles and for other propulsion needs. In its most general form, a lithium-sulfur (Li—S) battery consists of a lithium anode, a sulfur cathode and a separator interposed between them. The electrolyte is usually an organic solvent, or a mixture of organic solvents, that contain a lithium electrolytic salt.

Sulfur is low cost, abundant and offers high theoretical capacity. However, from the cathode side, the major limitations of the battery are 1) the insulating nature of sulfur (necessitating incorporation of conductive additives at the expense of active sulfur and a current collector that is affixed to the electrode material) and 2) the unique redox chemistry of sulfur, namely, the formation of polysulfide intermediates with lithium (of the formula Li₂Sₓ, 2<x≤8), which are soluble in the electrolyte and shuttle between the electrodes. This is known as the polysulfide shuttle phenomena, which accounts for the loss of active material and capacity reduction upon cycling. Therefore, research on improving the performance of Li—S batteries mainly focuses on modifying the sulfur cathode.

One major approach to fabricating sulfur cathodes is based on melt-diffusion/impregnation: insertion of sulfur melt/sulfur vapors into porous carbon forms to reach high S percentage in a carbon-sulfur composite, say, around 60-75% by weight. As shown in U.S. Pat. No. 7,361,431, the sulfur-filled carbon is combined with a binder in an organic solvent to form a slurry, which is used to coat a current collector to form the cathode.

A different approach for fabricating a sulfur cathode involves the mixing of elemental sulfur, a conductive carbon material and a binder in a solvent to form a slurry with ˜60-75% by weight sulfur content based on the total of sulfur and all additives. The slurry is applied onto the surface of a current collector, e.g., a carbon-coated aluminum current collector. See U.S. Pat. No. 7,018,739, where a pair of binders were used instead of a single binder. In U.S. Pat. No. 7,018,739, a mixture consisting of sulfur powder, conductive carbon and poly (ethylene oxide) as a first binder in acetonitrile is subjected to ball milling. A powder blend is collected (i.e., the electrode material) and combined with a second binder like PVDF in isopropanol. The resulting slurry was applied on a Rexam current collector. A similar approach is shown in US 2015/0044550.

### The Invention

We have now found that the customary sulfur cathode configuration (based on a layer consisting of ball-milled elemental sulfur/conductive carbon/binder that is spread on a carbon-coated metal current collector) can benefit from adjoining a porous carbon layer to the carbon-coated metal current collector. In the cathode design of the invention, the porous carbon layer acts as a host for the sulfur active material. First, elemental sulfur/conductive carbon/binder mixture is incorporated into the porous carbon layer. Next, a carbon-coated metal current collector and the sulfur-loaded porous carbon layer are joined with the aid of a second binder, to provide good adhesion between these two parts. Experimental results reported below indicate that the proposed cathode design can improve the mechanical and electrochemical performance of sulfur cathodes, achieving high sulfur content and high sulfur loading. Full cell tests showed good cycling stability over large number of cycles.

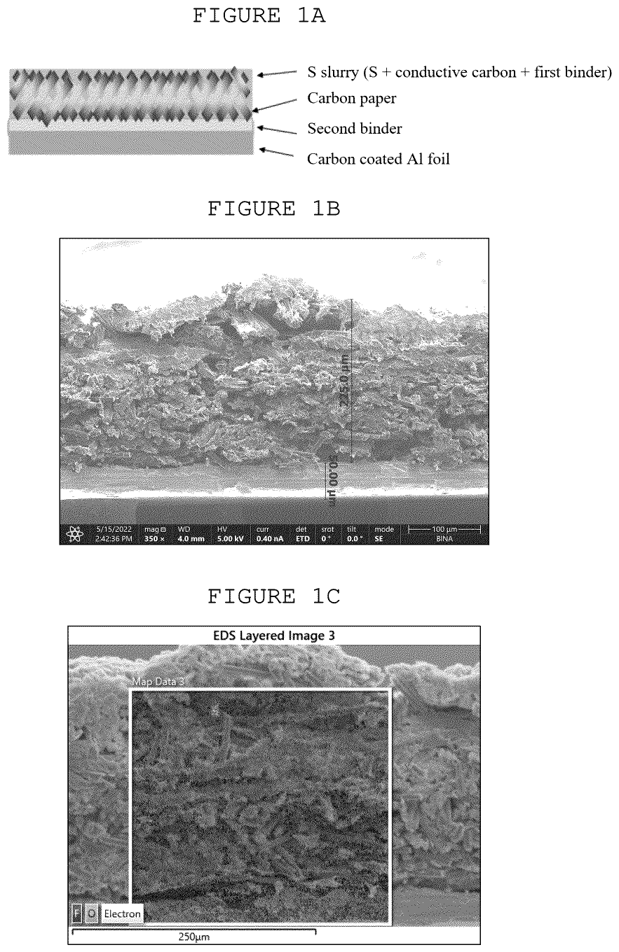

The design of the sulfur cathode proposed by one embodiment of the present invention is schematically illustrated in FIG. 1. It is in fact a dual-layer cathode made of a porous carbon layer (e.g., a carbon paper, which is usually about 100 to 500 μm thick), to which the active material was added, placed atop a carbon-coated metal current collector (e.g., Al foil), which is about 15 to 100 μm thick. The first and second binders serve different purposes. The first binder attaches the sulfur particles and conducting additive and aids in suppressing the polysulfide shuttle phenomena (i.e., fast dissolution of Li₂Sₓ reduction products from the cathode to the electrolyte solution during operation). The second binder supports the mechanical integrity of the dual-layer cathode, affixing the porous carbon layer to the current collector. The description below sets out the selection criteria for the two binders.

The first aspect according to the invention is a cathode for Li—S battery, comprising:
a current collector;
a cathode composite layer disposed on the current collector, wherein the cathode composite layer comprises (i) a porous carbon layer, (ii) a first binder that is at least partially in contact with the porous carbon layer and (iii) elemental sulfur; and
a second binder that is at least partially disposed between the current collector and the cathode composite layer.

The second aspect of the invention is a method of fabricating cathodes for Li—S batteries, comprising the following steps: applying onto a porous carbon layer, an aqueous slurry which comprises elemental sulfur and a first binder, and optionally, one or more conductive additives;
drying the sulfur-loaded porous carbon layer, to obtain a cathode composite layer; and
joining the cathode composite layer and a metal current collector with the aid of a second binder, to form a sulfur cathode.

The cathode composite layer comprises: (i) a porous carbon layer, (ii) a first binder and (iii) elemental sulfur. The cathode composite layer may further comprise (iv) conductive additives. The cathode of the invention has fairly high sulfur content. S content in the cathode (e.g. the content of the elemental sulfur in the cathode composite layer excluding the porous carbon layer) may be at least 60.0% by weight, e.g., ≥65.0% by weight, or ≥70.0% with cathode loading of not less 1.5 mg/cm², e.g., >2.0 mg/cm² and even >3.0 mg/cm², usually up to 4.0 mg/cm². For example, the mass of the elemental sulfur per unit area of the cathode composite layer is 3.0 mg/cm² or more. That is, the new design combines high sulfur percentage in the cathode mass with high areal loading.

The major selection criterion for the two binders is their swelling behavior in the organic electrolyte solutions operative in Li—S batteries. The first and second binders may show high and low swelling properties, respectively, measured by the rate of volume change when these materials are in contact with the ethereal electrolyte solutions relevant for Li—S cells. Examples are polyethylene oxide (PEO) and PVDF. PEO swells in the organic electrolyte solution while PVDF does not swell.

The first binder preferably has a greater swelling in an ether-based electrolyte solution than the second binder. Each of these two binders may contain a water-soluble polymer. Experimental work conducted in support of this invention indicates that good results are obtained when the first binder is based on poly (ethylene oxide) (PEO), either as a sole component or in combination with poly (vinyl pyrrolidone) (PVP). The second binder is usually a single component system based on poly (vinylidene difluoride) (PVDF). But there are other good options, as discussed below.

The method of fabricating the cathodes, and the cathodes design shown in FIG. 1, indicate that unlike the previously discussed U.S. Pat. No. 7,018,739 and US 2015/0044550, in the present invention, the binders are not evenly distributed across the dual-layer sulfur cathodes. Rather, the first binder is localized in the porous carbon layer, and the second binder is localized between the current collector and the porous carbon layer. The cross section of a dual-layer cathode of the invention described herein, that was fabricated using PEO as the first binder and PVDF as the second binder, was examined with the aid of scanning electron microscopy (SEM) equipped with energy-dispersive X-ray spectroscopy system (EDS-EDAX) which allowed identification of specific elements and their relative proportions (weight or atomic %).

FIG. 1B is the micrograph of the cross-sectional view of the dual-layer cathode. The boundary between the layers is clearly seen. The thickness of the top layer, consisting of the sulfur-loaded porous carbon layer, is from 200 to 250 μm (˜225 μm) and the thickness of the bottom layer, consisting of the carbon-coated aluminum current collector, is about ˜50 μm. The corresponding EDX spectrum is shown in FIG. 10. PEO has the formula [—CH₂—CH₂—O—]ₙ and is oxygen rich, whereas PVDF has the formula —[CH₂—CF₂—]ₙ and is fluorine rich. Hence, variation in the relative proportion of oxygen and fluorine measured by the EDX analyzer across the thickness of the cathode indicates the distribution of the binders between the two layers. In the present case, the EDS spectrum shows increasing oxygen and decreasing fluorine content (blue and red, respectively), moving in the thickness direction from the bottom layer (current collector) to the top layer (carbon paper). Although there is some intrusion of the first binder (PEO) from the carbon paper into the current collector, and some intrusion of the second binder (PVDF) into the carbon paper, primarily, each binder is preferentially localized either in the bottom or top layers.

Accordingly, the present invention relates to a dual-layer sulfur cathode as described above, wherein the first binder is preferentially localized across the cathode composite layer, while the second binder is preferentially localized over the boundary region between the current collector and the cathode composite layer.

The localization of the second binder can be confirmed by SEM-EDS mapping analysis as described above. For example, a dual-layer sulfur cathode is made of a sulfur-loaded porous carbon layer and a carbon-coated metal current collector. In addition, the sulfur cathode is prepared using PEO as the first binder and PVDF as the second binder. SEM-EDX measurement is performed for the sulfur cathode. When mapping analysis is performed for fluorine, as shown in FIG. 10, the strong signal intensity is observed near the interface between the carbon-coated metal current collector and the porous carbon layer. This means that elemental fluorine derived from PVDF is more abundant in the boundary between the two parts, confirming that the second binder is localized over the interface between them. In addition, the first binder is relatively more abundant in the porous carbon layer than in the area near the interface between the two parts.

Fabrication of the cathode includes two major steps. The first step consists of the application of a well-mixed slurry comprising elemental sulfur, a first binder and optionally conductive additive(s) onto a porous carbon layer, to obtain an S-loaded porous carbon layer which undergoes drying (forming a cathode composite layer). The second step is the attachment of the cathode composite layer onto a current collector (e.g., a bare or carbon-coated metal foil) using a second binder.

The slurry may be formulated by adding at least three components to a suitable liquid, preferably water, or a mixture of water and water-miscible alcohol, such as water/isopropanol mixture. The three components are:
1. High purity elemental sulfur in a powder form; the average particle size of the powder of elemental sulfur is preferably less than 1 μm, and more preferably 100 nm or less.
2. One or more conductive agents, namely, conductive carbon forms. Such carbon forms may be selected from various types of carbon black commonly used is lithium batteries, such as Super P, Ketjen black, acetylene black, carbon nanotubes (CNT, e.g., MWCNT) and vapor grown carbon fibers (VGCF).
3. The first binder (B1).

The first binder, which is incorporated into the aqueous slurry preparation stage, comprises one or more water-soluble polymers or copolymers that are capable of swelling in the electrolyte solution. Polyether such as PEO [weight average molecular weight(MW)=100000˜2000000, preferably 500000˜1000000], and poly (vinyl ether) (PVE), either alone or in combination with polyamide such as poly(vinyl pyrrolidone) [MW=100000˜2000000, preferably 500000˜1000000], were shown to achieve good results for the first binder. Owing to its swelling property, PEO encapsulates the sulfur active mass and mitigates detrimental interactions like dissolution of LiSₙ species from the composite cathode, to the electrolyte solution. When the first binder consists of multiple binders such polyether/polyamide blends (e.g., PEO/PVP), then the polyether is the predominate component, e.g., the blend is proportioned in the range of 2:1 to 20:1 (by weight). Other examples of water-soluble polymers that are well suited as part of the first binder in the slurry formation stage include poly (vinyl acetate) (PVA), water-based acrylates, carboxymethyl cellulose (CMC) and styrene-butadiene rubber (SBR).

The three solid components of the slurry (S/conductive carbon/B1) may be proportioned in the ranges from 60-80:0-25:5-20 by weight, preferably, 60-75:15-25:5-15 by weight, for example, 65-72:18-22:7-13, e.g., ˜70:˜20:˜10. The weight concentration of the S/conductive carbon/B1 blend in the slurry is in the range of from 7 to 25 wt. % (based on the total weight of the slurry). In other words, the content of the elemental sulfur in the cathode composite layer of the cathode for Li—S battery excluding the porous carbon layer is 65% by weight or more. The slurry for the cathode composite layer is prepared, for example, using a ball mill, a planetary mixer, or the like. A ball mill aids in obtaining a more homogeneous mixing of the sulfur and the conductive additives.

Porous carbon layers for use in the invention include carbon papers or carbon cloths that are 100 to 500 μm thick, such as those employed as gas diffusion layers in fuel cell (available commercially from manufacturers such as Toray, Sigracet and Freudenberg). Carbon papers (e.g., with nonwoven structure) with at least 60% total porosity (e.g., ˜70-80%), bulk density of 0.3-0.5 g/cm³ and average pore diameter >25 μm, e.g., >30 μm are suitable for use in the invention. Either hard and brittle carbon papers, or carbon papers showing some flexibility/compressibility, can be used.

One suitable coating technique to apply an aqueous slurry consisting of a suspension of elemental sulfur, the conductive carbon agent and the first binder onto the porous carbon layer is the doctor-blade technique. This involves spreading the slurry over the surface of, e.g., carbon paper, with the aid of a sharp blade to form a thin wet film, with penetration of the electrode material across the thickness of the carbon paper as confirmed by the SEM/EDX study reported above. The coated carbon paper is passed through an oven to evaporate the solvent(s) at about 70 to 90° C., for example.

The next step is the attachment of the porous carbon layer to the current collector. The current collector is usually a metal foil (or mesh) made of aluminum, stainless steel and copper. Aluminum is usually the metal of choice, thanks to its light weight and high corrosion resistance to elemental sulfur. A conductive carbon-coated metal foil is preferred over a bare foil, as the experimental results reported below indicate that good results were obtained with carbon-coated aluminum foil. The high purity (e.g., >99.9%) aluminum foil is about 8 to 50 μm thick; the conductive carbon layer applied (on one/both faces of the foil) is very thin, i.e., up to ˜2 μm thick on each side, e.g., up to 1 μm. The carbon layer (for example, Super P particles or their mixture with layered graphite) is attached to the metal foil by suitable adhesives, e.g., modified acrylates. Carbon-coated aluminum foils are available in the marketplace from many manufacturers.

Turning now to the second binder needed to join the current collector and the S-loaded carbon porous layer, it is important to choose polymeric binders that do not swell easily in the aprotic organic electrolytes that are commonly used in Li—S batteries. The polymeric binder, that needs to keep the mechanical integrity of the dual-layer sulfur cathode, interacts only to a small extent with the electrolyte solution. The electrolyte solution often consists of solvent(s) of low and intermediate polarity, e.g., with dielectric constants <10 at 25° C., such as ether-based solvents, either cyclic or linear, or mixtures of them. To determine the suitability of a candidate polymeric binder, a peeling test can be performed after exposure of the sulfur cathode to an ether-based solvent. This test can assess the detachability of the porous carbon sheet, that hosts the electrode material, from the carbon-coated Al current collector. Post-exposure peeling strength of above >200 g/cm², measured by the test described in the experimental section below, indicates that the polymeric binder tested confers good adhesion between the two parts of the dual-layer cathode. Such a polymeric binder is considered satisfactory and can be used as the second binder according to the invention. Polymeric binders that do not swell easily in ether-based solvents are fluoropolymers and copolymers, such as the above mentioned poly(vinylidene difluoride) (PVDF), poly(tetrafluoroethylene) (PTFE), a copolymer of PVDF and poly(hexafluoropropylene), ethylene-propylene-diene (EPDM) rubbers, acrylonitrile-butadiene rubber, styrene-butadiene rubber, acrylonitrile-butadiene-styrene, and sulfonated styrene/ethylene-butadiene/styrene triblock polymer. The second binder is preferably PVDF for the cathode of Li—S battery.

The joining of the cathode composite layer and the current collector by the second binder may be done in the following way. The second binder (preferably PVDF) is dissolved in an organic solvent, e.g., N-methyl pyrrolidone (NMP). The solution is applied to the surface of the carbon-coated Al current collector using a doctor-blade technique. The cathode composite layer is affixed to the current collector before the PVDF solution has dried. The bonded carbon-coated Al current collector and S-loaded porous carbon layer are placed in an oven at ˜80° C. to allow the solvent to dry. Additional carbon sources, such as Super P, Ketjen black, acetylene black, carbon nanotubes (CNT, e.g., MWCNT) and vapor grown carbon fibers (VGCF) may be also added to give better electroconductivity between the metal current collector (e.g., carbon-coated Al current collector) and the S-loaded porous carbon layer while joining the two components. The step of joining the two components may be integrated into commercial processes of carbon coating on top of Al foil, in which case the inclusion of the abovementioned carbon additives may not be needed.

The amount of the first binder in the cathode composite layer is generally greater than the amount of the second binder. Unlike the first binder, which provides swelling-derived effects, the second binder is used to increase the adhesion strength between the current collector and the porous carbon layer. Therefore, for increasing the capacity per unit area, it is preferable to use a small amount of binder, the minimal amount necessary to keep strong adhesion. Preferably, the weight ratio between the amounts of first and the second binders is >10, >20, >30 or >40.

The carbon source mentioned above, that may be optionally used to enhance electroconductivity between the current collector and the porous carbon layer, is added in a relatively small amount. Preferably, the weight ratio between the amounts of second binder and the additional carbon source is >1. It is likely that the carbon additive will be needed when the electrode is assembled by joining the individual components that were prepared separately (the carbon-coated Al current collector and the S-loaded porous carbon layer). As mentioned above, the electrodes may be manufactured by combining the steps of carbon coating on a metal foil with the step of joining of the carbon coated metal foil and the S-loaded carbon layer, in the absence of added carbon sources such as MWCNT and the like.

The dual-layer sulfur cathode is passed through an oven to evaporate solvents (˜80° C.), followed by vacuum drying stage at elevated temperature (˜60° C.) to remove remaining traces of solvents.

Another aspect of the invention is Li—S battery, comprising:
a dual-layer sulfur cathode as described herein;
a lithium anode, e.g., 8 to 50 μm thick lithium metal foil;
a separator interposed between the cathode and anode; and
an electrolyte solution filling the space between the cathode and anode.

To assemble a Li—S battery, a sheet of the dual-layer sulfur cathode, a separator and a lithium anode (after the welding of tabs) are sandwiched by rolling or layer stacking, packed/pressed into a housing made of plastic or metal, or packed as a pouch-type cell devoid of a rigid enclosure, in which the seal container is a flexible foil. Electrolyte solution is injected to fill the space between the electrodes.

The cathode of the present disclosure can be used in Li—S batteries. The Li—S battery comprises the cathode, an anode containing lithium, a separator disposed between the cathode and the anode and an electrolyte solution. For the Li—S battery, pouch-type cell is preferred, in which the high capacity per weight can be better utilized. The effects of the second binder of the invention tend to be more easily obtained with pouch-type cells.

The separator is usually a porous polymer sheet, chiefly polyolefin, namely, polyethylene, polypropylene, their blends and copolymers, available from manufacturers such as Celgard, e.g., Celgard 2500 polypropylene sheet.

An electrolyte solution that can be used in Li—S battery comprises an organic solvent and an electrolytic salt. Ether solvents (either linear or cyclic) such as dimethoxy ethane (DME), diethoxy ethane (DEE), tetrahydrofuran, 2-methyl tetrahydrofuran, 1,3-dioxalane (DOL), 2-methyl-1,3-dioxalane, 4-methyl-1,3-dioxalane, linear and cyclic glymes, such as diglyme CH₃O(CH₂CH₂O)₂CH₃ and tetraethylene glycol dimethyl ether CH₃O(CH₂CH₂O)₄CH₃ (TEGDME), and mixtures thereof, for example, a mixture consisting of DME and DOL, e.g., an equally proportioned (1:1 by volume) solvent mixture of DME and DOL or a solvent mixture consisting of TEGDME/DOL can be used. A helpful mini-review paper by Kaiser et al. (2017) [Structure-Property Relationships of Organic Electrolytes and Their Effects on Li/S Battery Performance. Advanced Materials, Online first 1700449-1-1700449-17] lists various solvents and their properties for Li—S batteries. The electrolyte solution is preferably ether solvents since it is less likely to react with sulfur.

Regarding the electrolytic salt, the salt of choice is lithium bis(trifluoromethylsulfonyl)imide (abbreviated LiTFSI), which is often added to ether solvent in Li—S batteries, as it dissociates well in such solvents, e.g., in DOL/DME mixture. Other lithium salts that can be mentioned as alternatives include lithium bis(pentafluoroethanesulfonyl)imide (abbreviated LiBETI), lithium hexafluorophosphate (LiPF₆), lithium tetrafluoroborate (LiBF₄), lithium hexafluoroarsenate (LiAsF₆), lithium perchlorate (LiClO₄). The concentration of the added lithium salt to the electrolyte solution is usually in the range from 0.5 to 4 M, preferably a 0.6M to 1.5M. Lithium nitrate is often added alongside a lithium salt selected from the list mentioned above. For example, the composition of a common electrolyte solution that was shown to achieve good results consists of 0.8-1.2M LiTFSI+0.1-0.4M LiNO₃ in DOL/DME. But high concentration lithium nitrate electrolytes devoid of the lithium salts mentioned above may also be considered, e.g., LiNO₃ in diglyme, as reported by Adams et al [Nano Energy volume 40, October 2017, Pages 607-617]. LiₓS (lithium sulfides) species can also be added to form homogeneous SEI layer.

Electrochemical results reported below indicate that customary configurations based on slurry coating of carbon-coated Al foil current collector do not enable effective sulfur loading. For instance, increasing the areal loading from 1.3 to 1.5 mg/cm², resulted in a sharp decrease of the obtainable specific capacity from around 820 to 430 mAh/g. With the incorporation of the porous carbon layer, in which the sulfur is encapsulated, the areal loading could be increased up to about 4 mg/cm², and yet reach specific capacities approaching 800 mAh/g (areal capacity of 2.2 mAh/cm²). With proper selection of the binders, good contact between the two parts of the dual-layer sulfur cathode is achieved, maintaining a reasonable cycling stability in highly loaded sulfur cathodes.

In the drawings

FIG. 1A is a schematic illustration of a dual-layer sulfur cathode according to the invention. FIGS. 1B and 10 show SEM images of cross-sectional view of the cathode, with the corresponding EDX data, indicating the distribution of the binders of the cathode across the z direction (the thickness direction).

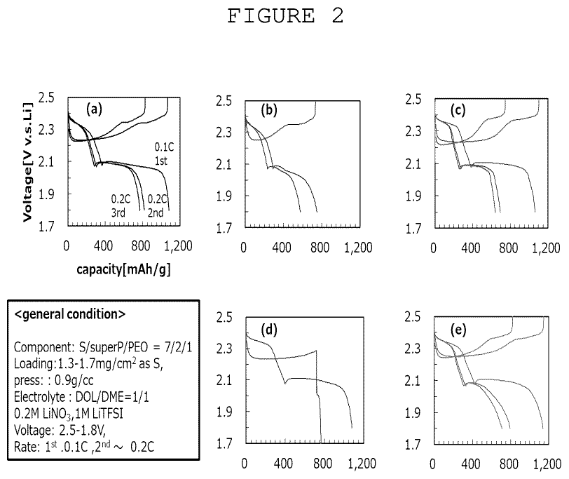

FIG. 2 shows initial charge/discharge voltage profiles of Li—S cells with cathodes containing 70% elemental sulfur, with different S loading and current collectors: (a) carbon coated Al with S loading of 1.3 mg/cm² (b) carbon coated-Al with S loading of 1.7 mg/cm² (c)carbon paper with S loading of 1.7 mg/cm² (d) carbon coated-Al and carbon paper (without adherence) with S loading of 1.7 mg/cm², and (e) carbon coated Al to which a carbon paper is well adhered, with S loading 1.7 mg/cm² of.

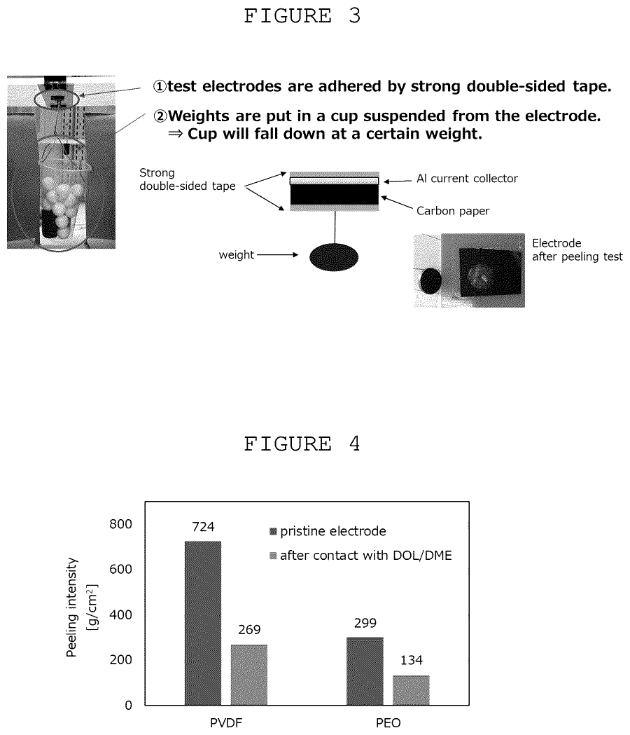

FIG. 3 shows the experimental set-up of the peeling tests.

FIG. 4 is a bar diagram with the results of the peeling test.

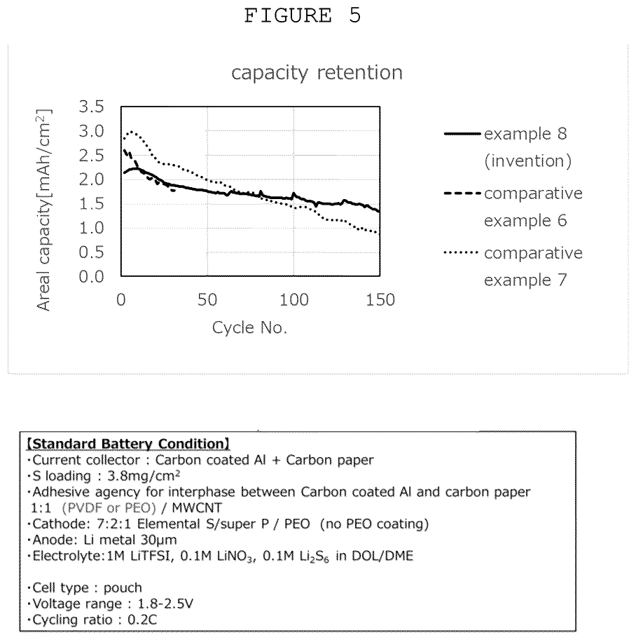

FIG. 5 is a plot of areal capacity versus cycle number for different cathode designs (i.e., PEO or PVDF used as the second binder).

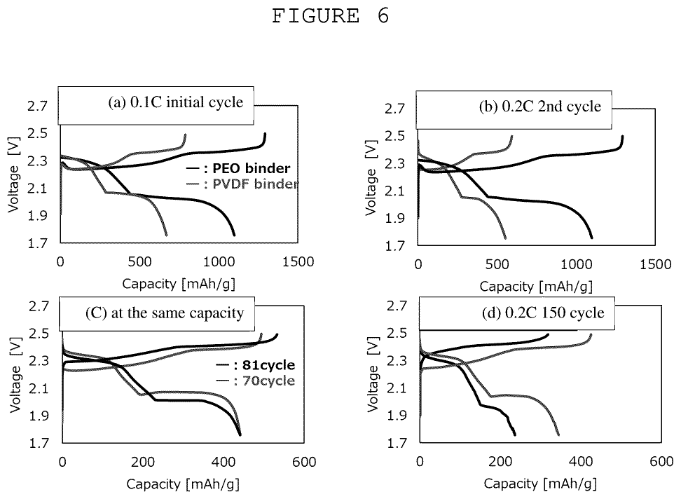

FIG. 6 shows comparison of charge/discharge voltage profiles with PEO and PVDF binders in galvanostatic cycling at initial (a), second (b), 70^{th} and 81^{st} (same specific capacity, c) and 150^{th} (d) cycles. First cycle was at 0.1C rate, then 0.2 C rate.

### EXAMPLES

### Examples 1 to 5 (Comparative)

### Fabrication and Testing S-Cathodes of Different Structures

The goal of the study was to evaluate the electrochemical performance of Li—S cells based on different configurations of sulfur cathodes. All sulfur cathodes contained 70% sulfur (by weight), with different total sulfur loading per cm², and different cathode designs, as shown below. The major steps include preparation of a sulfur slurry, its application onto a current collector to form a sulfur cathode, and assembly of the cathode with lithium anode and a separator to form the electrochemical cell.

Elemental sulfur (99.98% Aldrich), carbon black (TIMCAL Super C65), PEO (MW=600000) and PVP (K90) with weight ratio of 70/20/9.5/0.5, respectively, were mixed by ball milling with water/IPA 1:1 as the solvent, at 180 rpm for 10 h, to form a slurry.

The slurry was applied, using a doctor blade, either directly on a carbon-coated aluminum current collector (TOYAL-CARBO) or on a carbon paper (Toray carbon paper H30) to achieve 1.3-1.7 mg/cm² of sulfur loading. Different electrode configurations were prepared, as tabulated in Table 1 below (Examples 1 and 2: S-loaded carbon-coated aluminum current collector; Example 3: S-loaded carbon paper; Example 4: S-loaded carbon paper located on a carbon-coated aluminum current collector; Example 5: S-loaded carbon paper joined to carbon-coated aluminum current collector with the aid of PEO binder; the PEO binder was applied on carbon-coated aluminum foil, then the S-loaded carbon paper was placed on top of the carbon coated aluminum foil to join the two components). The data is arranged in a tabular form in Table 1.

TABLE 1

| | | | | 0.1 C | | 0.2 C | |
|---|---|---|---|---|---|---|---|
| | | | | | areal | | areal |
| | | Second | S loading | capacity | capacity | capacity | capacity |
| Example | Cathode design | binder | (mg/cm2) | (mAh /g) | (mAh/cm²) | (mAh/g) | (mAh/cm²) |
| 1 | S-loaded carbon- | — | 1.3 | 1084 | 1.41 | 817 | 1.06 |
| comparative | coated Al foil | | | | | | |
| 2 | S-loaded carbon- | — | 1.7 | 608 | 1.03 | 431 | 0.73 |
| comparative | coated Al foil | | | | | | |
| 3 | S-loaded carbon | — | 1.6 | 1067 | 1.71 | 695 | 1.11 |
| comparative | paper | | | | | | |
| 4 | S-loaded carbon | — | 1.7 | 1082 | 1.84 | 0 | 0 |
| comparative | paper and a | | | | | | |
| | carbon-coated Al | | | | | | |
| | foil | | | | | | |
| 5 | S-loaded carbon | PEO | 1.7 | 1139 | 1.94 | 796 | 1.35 |
| comparative | paper and a | | | | | | |
| | carbon-coated A1 | | | | | | |
| | foil | | | | | | |

The electrodes were dried during 6 hours at 60° C. and then dried again for 3 hours at 60° C. with vacuum before they were assembled to form the cells for testing. Pouch type cells were assembled with 125 μm thick Li foils anodes, Celgard 2500 polypropylene separators and 0.5 ml 1M LiTFSI DOL/DME (1:1, by volume) electrolyte with 0.1M LiNO₃ and 0.2M Li₂S₆ as additives. All sample preparations except for the slurry making process were carried out in a glovebox (MBRAUN) under pure argon with less than 1 ppm water level.

Electrochemical measurements were done by computerized multichannel electrochemical measurement equipment from Arbin (USA). Constant current cycling measurements were carried out to assess the stability of each system (electrodes, solutions). Cycling tests were carried at 0.2 C rate (10=1674 mAh/g), at 30° C. The electrochemical performance of the cells was evaluated, and charge-discharge profiles are shown as plots of voltage (V vs Li) against capacity (mAh/g) in FIGS. 2a-2e, which correspond to Examples 1 to 5 (all comparative), respectively. The specific capacity values per cm² were calculated for fully discharging the cathodes at 0.2 C rate. The specific energy density values were calculated herein per the weight of the cathodes only.

From FIGS. 2a and 2b one can see that carbon coated Al foil current collectors provided high specific capacity, however when the sulfur loading in the cathodes was increased from 1.3 (Example 1; FIG. 2a) to 1.7 mg/cm² (Example 2; FIG. 2b), there was a drastic decrease in the rate capabilities of the cells. This implies that sulfur loading cannot be increased simply by using carbon coated Al foil.

Replacing carbon coated Al foil with carbon paper (Example 3, FIG. 2c) with a similar sulfur loading of 1.7 mg/cm² showed improved 0.1 C rate discharge capacity, indicating that this 3D structured current collector enhances the electronic conductivity to elemental sulfur in the z direction (the thickness direction). However, the 0.2 C rate discharge capacity is still lower compared to electrodes based on carbon coated Al foil with 1.3 mg/cm² sulfur loading (Example 1; FIG. 2a). Carbon paper (3D) alone as a current collector thereby cannot achieve high rate property due to its insufficient electronic conductivity.

FIGS. 2d and 2e correspond to the combination of the carbon-coated Al foil and carbon papers. In the case where the carbon paper was just placed atop of Al foil, initial 0.1 C rate discharge capacity was observed, but further charging failed, and the cell was short-circuited, presumably owing to a severe shuttling effect, which did not allow to continue cycling. On the other hand, the cells showed initially high 0.1 C and 0.2 C rate specific capacity values after assembling.

### Examples 6 and 7 (Comparative) and 8 (of the Invention)

### Joining S-Loaded Carbon Paper and Carbon-Coated Al Foil with Different Binders

The goal of the study was to assess the effect of different binders applied in the interface between the two parts of the cathode (the S-loaded carbon paper and the carbon-coated Al foil). Cathodes were prepared according to the procedure set out in previous examples, using PEO for slurry formation; but to join the S-loaded carbon paper to the Al foil, either PEO binder with 3.1 mg/cm² S loading (Example 6, comparative), PEO binder with 3.8 mg/cm² S loading (Example 7, comparative), or PVDF binder with 3.9 mg/cm² S loading (Example 8, of the invention) were used. Mixed slurry consisting of the second binder (either PEO or PVDF), MWCNT and NMP was applied on the carbon-coated aluminum, followed by placing the S-loaded carbon paper on top of the carbon coated aluminum foil to join the two components. The electrodes were dried; the loading of both the second binder and MWCNT onto the electrodes was 0.05 mg/cm².

The study consists of two parts, A and B.

Part A: Measuring Adhesion Strength

The goal of the first part of the study was to examine the efficacy of the binders in maintaining the integrity of the cathode structure, namely, attaching the two parts of the cathode (the S-loaded carbon paper and Al foil), not only when the cathodes are dry, but also when they are in contact with an electrolyte solution.

The experimental set-up used for quantification of the adhesion strength between the S-loaded carbon paper and Al foil is shown in FIG. 3. Peeling tests were done using strong double-sided tape and weight balls. The cathode, consisting of the S-loaded carbon paper and carbon-coated Al foil joined with the tested binder was adhered to a surface using the double-sided tape. The balls were successively added to a cup suspended from the cathode until the total weight exceeded the adhesion force, causing the cup to fall. As the tape was strong, it was assumed that the location of the weakest adhesion would be the interface between the two parts of the composite electrodes. Indeed, an image of the cathode that was taken after the peeling test confirmed that the two parts—the S-loaded carbon paper and the Al foil—detached. See the photo in the right part of FIG. 3.

The results are shown in the form of a bar diagram in FIG. 4 (for Examples 7 and 8). There are two pairs of adjacent bars, each pair relates to a different binder. In each pair, the left-hand (blue) bar corresponds to the original cathode and the right-hand (orange) bar to the cathode, after it was immersed in a DOL/DME electrolyte solution for 1 hour. The ordinate is the peeling strength, which means that effects of the electrolyte solution (level of swelling) on adhesion strength is calculated by measuring weight and the electrodes area.

FIG. 4 shows that the S-loaded carbon paper and the carbon-coated Al foil are joined with PVDF effectively. It is noted that adhesion strength conferred to the cathode structure by both PVDF and PEO drops after the exposure of the cathode to the electrolyte solution. Still, PVDF was able retain its initial advantage over PEO and in fact the post-exposure peeling strength measured for PVDF was roughly comparable to that measured for PEO before exposure to the electrolyte solution. The results of the peeling tests (for Examples 7 and 8) are also shown in a tabular form in Table 2 below.

Part B: Measuring Pouch-Type Cell Performance

The goal of the second part of the study was to assess the effect of the binders applied in the interface between the two parts of the cathode (the S-loaded carbon paper and the carbon-coated Al foil) on the electrochemical performance of cells employing such cathode.

Pouch type cells were assembled with 30 μm thick Li foils anodes and Celgard 2500 polypropylene separators. The electrolyte consisted of 0.5 ml of 1M LiTFSI in DOL/DME (1:1, by volume), with 0.1M LiNO₃ and 0.1M Li₂S₆ as additives. All sample preparations except for the slurry making process were carried out in a glovebox (MBRAUN) under pure argon with less than 1 ppm water level.

Cycling tests were performed. To assess the degree of capacity retention achieved by the three types of cells (Example 6, 7 and 8), the results of cycling tests are shown graphically (FIG. 5; a plot of a areal capacity versus cycle number for 150 cycles) and also in a tabular form (Table 2; in Table 2, Qcyc(1) and Qcyc(150) indicate the capacities after the first cycle and after 150 cycles, respectively; the ratio Qcyc(150)/Qcyc(1) was calculated and expressed as percentage in Table 2).

In FIG. 5, the solid line represents the curve corresponding to Example 8, i.e., the cell of the invention, whereas the dashed and dotted lines represent the results for comparative Examples 6 and 7, respectively. The comparative cells showed significant fading during cycling. In contrast, cells with PVDF-containing cathodes showed significantly better cycling stability, attributed to strong adhesion between the two components of the composite cathodes, which improved the electronic conductivity of the electrodes.

The different cathode designs of Examples 6, 7 and 8, parameters of the electrochemical performance and peeling strength measurements are set out in Table 2.

TABLE 2

| | | | | 0.2 C | | cycling | | |
|---|---|---|---|---|---|---|---|---|
| | | | | | areal | test | peeling strength | |
| | | Second | S loading | capacity | capacity | Qcyc (150)/ | before | after |
| Example | Cathode design | binder | (mg/cm2) | (mAh/g) | (mAh/cm²) | Qcyc (1) | exposure | exposure |
| 6 | S-loaded carbon paper | PEO | 3.1 | 892 | 2.77 | — | — | — |
| comparative | and a carbon-coated | | | | | | | |
| | Al foil | | | | | | | |
| 7 | S-loaded carbon paper | PEO | 3.8 | 805 | 3.06 | 30 | 299 | 134 |
| comparative | and a carbon-coated | | | | | | | |
| | Al foil | | | | | | | |
| 8 | S-loaded carbon paper | PVDF | 3.9 | 566 | 2.21 | 78 | 724 | 269 |
| invention | and a carbon-coated | | | | | | | |
| | Al foil | | | | | | | |

FIG. 6 compares the charge/discharge voltage profiles of the electrodes containing different binders at initial 0.1 C and 2 nd 0.2 C rate in experiments of similar specific capacity, during 150 cycles. Electrodes operated at initial 0.1 C and 2nd 0.2 C rate showed typical charge/discharge profiles of Li—S batteries. Cells with PVDF showed less capacity, but their voltage profiles were typical to Li—S cells. Interestingly, for electrodes having the same specific capacity, after 81 cycles (PEO) and 70 cycles (PVDF), the charge/discharge profiles showed different voltage profiles.

Usually, the voltage drop/increase at the beginning of charge/discharge cycling is attributed to the resistance of the electrodes, however, with Li—S cells, we cannot discuss the electronic conductivity at the beginning of charge, as insulating Li 2 S precipitates on the cathode, thus the first stage of the charging process relates to oxidation of an insulating material. However, we can still discuss the electronic conductivity of composite sulfur electrodes at the beginning of discharge. The electrodes with PEO showed a lower voltage plateau, reflecting an initial IR drop and consequently lower electronic conductivity, compared to electrodes with PVDF binder. This result regarding the voltage profile at the beginning of discharge is in line with the results of the peeling test. It is concluded that the cycling performance was improved by achieving better adhesion using PVDF between the two cathodes' components, resulting in more stable electronic conductivity (see FIG. 6).

1. A cathode for Li—S battery comprising:
a current collector;
a cathode composite layer disposed on the current collector, wherein the cathode composite layer comprises (i) a porous carbon layer, (ii) a first binder that is at least partially in contact with the porous carbon layer and (iii) elemental sulfur; and
a second binder that is at least partially disposed between the current collector and the cathode composite layer.

2. The cathode for Li—S battery according to claim 1, wherein the current collector is a metal current collector coated with carbon.

3. The cathode for Li—S battery according to claim 1, wherein the cathode composite layer further comprises (iv) conductive additives.

4. The cathode for Li—S battery according to claim 1, wherein the first binder is localized across the porous carbon layer, and the second binder is localized over the boundary region between the current collector and the cathode composite layer.

5. The cathode for Li—S battery according to claim 1, wherein each of the first binder and the second binder contains a water-soluble polymer.

6. The cathode for Li—S battery according to claim 1, wherein the first binder has greater swelling in an ether-based solvent than the second binder.

7. The cathode for Li—S battery according to claim 1, wherein the first binder comprises polyethylene oxide and the second binder comprises poly (vinylidene difluoride).

8. The cathode for Li—S battery according to claim 1, wherein the content of the elemental sulfur in the cathode composite layer excluding the porous carbon layer is 65% by weight or more.

9. The cathode for Li—S battery according to claim 8, wherein the mass of the elemental sulfur per unit area of the cathode composite layer is 3.0 mg/cm² or more.

10. A Li—S battery comprising:
the cathode for Li—S battery according to claim 1;
an anode containing lithium;
a separator interposed between the cathode and the anode;
and an electrolyte solution.

11. A method of fabricating a cathode for Li—S batteries, comprising the steps of:
applying onto a porous carbon layer, an aqueous slurry which comprises elemental sulfur and a first binder, and optionally, one or more conductive additive(s);
drying the sulfur-loaded porous carbon layer, to obtain a cathode composite layer; and
joining the cathode composite layer and a metal current collector with the aid of a second binder, to form a sulfur cathode.

12. The method of fabricating a cathode for Li—S battery according to claim 11, wherein the first binder has greater swelling in an ether-based solvent than the second binder.
